(19) United States
(12) Patent Application Publication
(10) Pub. No.: US 2015/0285766 A1
(43) Pub. Date: Oct. 8, 2015

(54) ELECTROKINETIC CHROMATOGRAPHY PRECONCENTRATION METHOD

(71) Applicant: The Government of the United States of America, as represented by the Secretary of the Navy, Washington, DC (US)

(72) Inventors: Braden C. Giordano, Reston, VA (US); Dean S. Burgi, Sunnyvale, CA (US)

(73) Assignee: The Government of the United States of America, as represented by the Secretary of the Navy, Washington, DC (US)

(21) Appl. No.: 14/677,227

(22) Filed: Apr. 2, 2015

Related U.S. Application Data
(60) Provisional application No. 61/974,586, filed on Apr. 3, 2014.

(51) Int. Cl. G01N 27/447

(52) U.S. Cl. CPC G01N 27/44765; G01N 27/44743; G01N 27/44791

(57) ABSTRACT

Methods of electrokinetic chromatograph that produce focusing of an analyte. This may be done by creating an electroosmotic flow gradient in the background electrolyte near the sample matrix.

This application claims the benefit of U.S. Provisional Application No. 61/974,586, filed on Apr. 3, 2014. The provisional application and all other publications and patent documents referred to throughout this nonprovisional application are incorporated herein by reference.

### TECHNICAL FIELD

The present disclosure is generally related to preconcentration in electrokinetic chromatography.

### DESCRIPTION OF RELATED ART

Electrokinetic chromatography is a mode of capillary electrophoresis that allows for the separation of neutral analytes and weakly charged species. Briefly, capillary electrophoresis is a separation technique wherein a small diameter glass capillary or other fluid channel is filled with a liquid separation media, often referred to as the background electrolyte (BGE). Analyte of interest is injected in what is commonly referred to as the sample matrix (SM), and a potential is applied across the capillary. All of the constituents of the BGE and SM including the analyte begin to migrate in this electric field. Constituents of the SM including analyte separate in the electric field based upon their electrophoretic mobility, which is proportional to their charge-to-shape ratio. In normal mode capillary electrophoresis the inlet (where sample is injected) is the (+) electrode and the outlet (where sample exits the capillary) is the (−) electrode. Sample is injected as a mixture, and is detected as zones at some point along the length of the capillary.

A secondary event to the electrophoretic process is electroosmotic flow (EOF). Briefly, deprotonated silanol groups on the glass capillary surface attract cations from the BGE. The result is a positively charged ionic layer on the surface that decays exponentially as distance from the from the wall increases. This layer is commonly referred to as the Stern layer. Next to the Stern layer, one finds the Outer Helmholtz Plane. Application of an electric field results in cations in the Outer Helmholtz Plane to move towards the (−) electrode. Due to strong waters of hydration surrounding these cations, coupled to the intrinsic strength of hydrogen bonding between water molecules; the entire solution in the capillary moves towards the (−) electrode. This movement is called “bulk flow” and has non-laminar or a planar profile. Bulk flow serves to carry cations, neutral components, and anions from the inlet side of the capillary to the outlet side of the capillary. The magnitude of EOF or bulk flow is dependent on numerous factors including pH (affecting the degree of deprotonation on the capillary wall), viscosity, and solution permittivity.

Since the basis for separation in capillary electrophoresis is charge-to-shape ratio, it is clear that the ability to separate uncharged species is not possible using the technique described above. All neutral components, regardless of shape, would migrate together. In order to separate a mixture of neutral components, a technique called Micellar Electrokinetic Chromatography or MEKC, was developed. Briefly, a surfactant micelle, sometime referred to as an electrokinetic vector, is added to the BGE. Analyte interacts with the micelle, thus taking on the mobility of the micelle. Therefore, the observed mobility of an analyte is the average of the time the analyte migrates with EOF and the time it migrates with the micelle. Alternatives exist to micelles as electrokinetic vectors including vesicles and microemulsions. The key feature in this mode of electrophoresis is that upon interaction of the electrokinetic vector, analyte velocity changes.

One consequence of this mechanism of separation is that when the sample matrix does not contain the surfactant, the analyte will preconcentrate as it interacts with the micelle in the BGE. This phenomenon has been referred to as sweeping or stacking. There has been some debate in the literature as to whether or not sweeping or stacking represents different preconcentration mechanisms or that they are the same mechanism just implemented in a different region of the parameter space. Ultimately, the key to both methods is that the analyte experiences a change in velocity as it interacts with the surfactant micelle. This event is often referred to as velocity induced stacking.

One can consider this mechanism of stacking as monodirectional, that is to say, the preconcentration occurs at one boundary between the SM and the BGE and the extent of preconcentration is only dependent on the affinity of the analyte for the micelle. There are several examples of preconcentration, while there are many different ways to identify a given preconcentration technique, arguably the key features necessary to understand a given mode are 1) the magnitude/direction of EOF, 2) the nature of the discontinuity between the SM and BGE, and 3) the net charge of the surfactant micelle. For the purposes of this discussion only examples of preconcentration/separation with anionic surfactant micelles are used. All examples contained herein would apply to any anionic electrokinetic vector.

MEKC preconcentration and separation can be loosely classified as occurring under 1) high

EOF conditions or 2) low EOF conditions. Under the first condition, high EOF, all ions (cations and anions) move from the (+) electrode to the (−) electrode. When a discrete plug of SM containing analyte is injected into the capillary and a potential is applied, two things occur. Surfactant micelles begin to preconcentrate at the SM/BGE boundary closest to the detector (outlet side of the sample plug). This micelle preconcentration is considered a transient isotachophoretic event and is dependent upon the relative conductivity length of the sample plug. At the same time, analyte moves with the velocity of EOF into that stacking micelle boundary and preconcentrates due to the interaction with the micelle. The analytes with the highest affinity for the micelle preconcentrate the most and reach the detector late in the separation. Those with a low affinity for the micelle preconcentrate the least and reach the detector early in the separation. Ultimately, all components of the SM pass the detector and the separation window is defined as the time it takes EOF to reach the detector on one side and the time it takes for the SM/BGE outlet side boundary to reach the detector as the other side.

Alternatively, in the second, low EOF, condition, the polarity is reversed. The (−) electrode is the inlet electrode and (+) is the outlet electrode. The discrete injection of sample matrix followed by the application of the separation voltage is followed by stacking of the surfactant micelle at the inlet side SM/BGE boundary (again dependent on the relative conductivity length of the sample plug). In this instance, the magnitude (i.e. velocity) of EOF is so small that the anionic micelles move from the inlet side vial towards the outlet side vial, and pick-up or sweep the immobile neutral analytes (thus the term sweeping used to describe this mode of preconcentration). As with the previous example, the key is the velocity difference between analyte in the SM (in this case virtually zero) and in the BGE ultimately dependent upon the analytes affinity for the micelle. The analytes with most affinity for micelle reaches the detector first while analytes with little or no affinity for the micelle do not reach the detector in a timely fashion. In many cases, low affinity analytes in this mode of stacking so slowly reach the detector that any benefit of preconcentration is lost to diffusion during the separation process.

While the two modes of MEKC preconcentration/separation described above are only a small sample size of the breathe of research that has been done in this area, the fact remains that the fundamental mechanism of analyte preconcentration is that the analyte experiences a change in velocity of the analyte at is interacts with the SM/BGE boundary and that interaction is monodirectional. The monodirectional nature of the interaction is of key importance. The extent of preconcentration is only dependent on the magnitude of the velocity differences, which is ultimately governed by a given analytes affinity for the electrokinetic vector.

### BRIEF SUMMARY

Disclosed herein is a method comprising: providing an electrokinetic chromatograph comprising a fluid channel comprising an inlet end and an outlet end, a background electrolyte comprising an electrokinetic vector filling the fluid channel, an inlet buffer container, an outlet buffer container, a voltage supply, and a detector; injecting a sample matrix into the inlet end; and applying a voltage across the fluid channel using the voltage supply for a time sufficient to allow an analyte in the sample matrix to be detected by the detector. The chromatograph, the background electrolyte, and the sample matrix are configured to produce: a hydrodynamic flow, an electroosmotic flow, or a combination thereof towards the outlet end in the background electrolyte; a hydrodynamic flow, an electroosmotic flow, or a combination thereof towards the outlet end in the sample matrix that is greater than the flow in the background electrolyte; and a micelle velocity towards the inlet end.

Also disclosed herein is a method comprising: providing an electrokinetic chromatograph comprising a fluid channel comprising an inlet end and an outlet end, a background electrolyte comprising an electrokinetic vector filling the capillary, an inlet buffer container, an outlet buffer container, a voltage supply, and a detector; injecting a sample matrix into the inlet end; and applying a voltage across the fluid channel using the voltage supply for a time sufficient to allow an analyte in the sample matrix to be detected by the detector. The chromatograph, the background electrolyte, and the sample matrix are configured to produce: a hydrodynamic flow, an electroosmotic flow, or a combination thereof towards the outlet end in a portion of the background electrolyte closer to the outlet end; a hydrodynamic flow, an electroosmotic flow, or a combination thereof towards the outlet end in the sample matrix; a micelle velocity in the portion of the background electrolyte towards the outlet end that is less than flow in the portion of the background electrolyte; and an electroosmotic flow gradient between the portion of the background electrolyte and the sample matrix.

### BRIEF DESCRIPTION OF THE DRAWINGS

A more complete appreciation of the invention will be readily obtained by reference to the following Description of the Example Embodiments and the accompanying drawings.

FIG. 1 schematically shows a method of MEKC preconcentration.

FIG. 2 schematically shows another method of MEKC preconcentration.

FIG. 3 shows a series of electropherograms demostrating formation of an EOF gradient.

FIG. 4 shows a series of electropherograms demostrating analyte focusing.

FIG. 5 shows a demonstration of analyte focusing.

### DETAILED DESCRIPTION OF EXAMPLE EMBODIMENTS

In the following description, for purposes of explanation and not limitation, specific details are set forth in order to provide a thorough understanding of the present disclosure. However, it will be apparent to one skilled in the art that the present subject matter may be practiced in other embodiments that depart from these specific details. In other instances, detailed descriptions of well-known methods and devices are omitted so as to not obscure the present disclosure with unnecessary detail.

Disclosed herein is a new mechanism of preconcentration in electrokinetic chromatography or MEKC that is bidirectional—an electrophoretic phenomenon commonly referred to as focusing. The purpose is to significantly improve on-line sample preconcentration in capillary electrophoresis-based separations in the presences of surfactant micelles or other electrokinetic vectors through careful control of the injection/separation parameter space. The consequence of this level of control is to induce bi-directional preconcentration or focusing of analyte in the appropriate electrophoretic systems to a steady state partitioning location. The consequence is that analyte migrates to a discrete zone based upon its affinity for the micelle where appropriate conditions that result in focusing as established.

In isoelectrofocusing, mixtures of proteins (i.e., analytes of interest) and ampholytes are injected into a capillary. At one end of the capillary is a high pH solution while at the other a low pH solution is placed. Application of a voltage results in the establishment of a pH gradient. Analytes migrate in that pH gradient until they reach a point where their net charge is neutral (isoelectric point). Should the analyte take on a charge, they will migrate away from that point becoming either positively or negatively charged and migrate accordingly in the pH gradient. The analyte will immediately feel the effect of the new charge and be compelled to return to its isoelectic point. Consequently, analyte is said to focus at the position within the capillary (or pH gradient) where it is net neutral.

It is possible to induce IEF-like behavior in MEKC systems by tailoring of sample matrix and background electrolyte composition. A stacking phenomenon is distinguishable from a focusing phenomenon. Stacking is a mono-directional mechanism of preconcentration. In MEKC traditional stacking is based upon a mobility difference between analyte in a sample matrix (migrating at the velocity of EOF) and analyte in the BGE (migrating at a velocity lower than EOF due to interaction with a surfactant micelle or any other electrokinetic vector). In a high EOF MEKC system, it is said that sample “stacks” at the detector side interface of the sample matrix and the BGE. Focusing is a bi-directional preconcentration process. Using the interface analogy; analyte would stack at the detector side interface between sample matrix and BGE and analyte migrating away (towards the detector) from that interface faster than the velocity of the interface would be brought back to the interface based upon its affinity for the micelle.

This focusing becomes more prominent as the micelle is made to move towards the inlet-side of the capillary (such that the |μ_{mc}|>μ_{eof}), in the case of a high EOF system. One also needs to consider differences in local EOF in the sample matrix and the BGE and the potential role they play on maintenance of the focusing steady-state. It should be noted that the above condition with respect to micelle and EOF mobility can be met as either an intrinsic property of the BGE, or induced by long electrokinetic injections of sample with some sort of EOF suppression capability (i.e. high ionic strength); thus one can conclude that one or both “modes” of MEKC focusing exist at any given time. It is therefore possible that a local EOF gradient is generated on the detector side of the sample matrix/BGE interface as charged sample matrix components migrate through the interface into the BGE proper. This may serve to enhance the focusing effect as a function of time and result in analytes that endure both traditional stacking and a transition to focusing. The penetration of EOF suppressors into the BGE, would imply that this would be a local effect . . . that is to say sample that migrates through the interface first and is only stacked, will migrate beyond the influence of the “focusing” regime before it has the chance to develop. Consequently, all injected low k analytes may not focus because they have migrated beyond the focusing influenced region, while higher k analytes feel the full effect of the focus. In order to ensure focusing of low k analytes it would be necessary to drive the focusing phenomenon from the perspective of BGE composition.

The clear advantage is to transition preconcentration in MEKC systems from a mono-directional, velocity induced modality, to a bi-directional process that incorporates velocity induced preconcentration in two directions. The result is a much improved preconcentration of analyte resulting in better sensitivity and selectivity for a given separation.

Ross and coworkers developed a technique called Micellar Affinity Gradient Focusing (J. Am. Chem. Soc. 2004, 126, 1936-1937). Their mechanism of focusing was made possible by applying a temperature gradient across the separation channel while simultaneously applying a separation voltage across a BGE containing surfactant micelles. Critical micelle concentration (C_{mc}) is the surfactant concentration necessary to induce the formation of the surfactant micelle from the monomer units in solution. This concentration is dependent upon a number of factors, including temperature. By incorporating a temperature gradient across the separation channel, the authors induce a micelle collapse at some point in the channel, consequently, a given analyte will have a point in the orthogonal micelle/temperature gradients that it will migrate towards and stop in a fashion analogous to IEF. This mode of focusing has been implemented by others (Ren et al., Electrophoresis, 2012, 33, 2703-2710; Ross et al., US Pat. No. 7,718,046).

A key distinction here is that the disclosed method of analyte focusing is not a function of changing an analyte's affinity for the micelle, but changing the velocity of the analyte when not in the micelle. On the SM side of the SM/BGE boundary, analyte moves with one EOF velocity, while on the BGE side of the SM/BGE boundary, analyte moves with a different EOF velocity. Differences in measured analyte velocity on the BGE side of the boundary are due to the analyte's affinity for the micelle, not a change in the affinity for the micelle.

Palmer and coworkers proposed conditions under which our focusing mechanism would occur, but did not acknowledge the fact that the mechanism would be bi-directional (Analytical Chemistry, 2002, 74, 632-638). It should also be noted that Palmer demonstrated conditions under which the detector side SM/BGE boundary moved, albeit slowly, towards the detector. In that regard, no focusing was demonstrated.

The disclosed methods may be performed with a standard electrokinetic chromatography or MEKC apparatus that includes a fluid channel comprising an inlet end and an outlet end, a background electrolyte comprising micelles filling the capillary, an inlet buffer container, an outlet buffer container, a voltage supply, and a detector. Such equipment is known in the art and described in Landers, James P., ed. Handbook of Capillary and Microchip Electrophoresis and Associated Microtechniques, 3^{rd} ed. Boca Raton: CRC, 2008 (Chapters 3 and 13). Any references herein to micelles are also applicable to other electrokinetic vectors. The fluid channel may be, for example a capillary, a microfluidic channel, including as part of a microchip, other planar fluid channels, or any other glass channel appropriate for electrokinetic chromatography. Any references herein to capillaries are also applicable to other fluid channels. After setup, a sample matrix is injected into the inlet end and a voltage applied across the capillary using the voltage supply for a time sufficient to allow an analyte in the sample matrix to be detected by the detector. The conditions described below produce a local zone of bidirectional preconcentration, or focusing of analyte/analytes into discrete zones based upon an analytes affinity for the micelle.

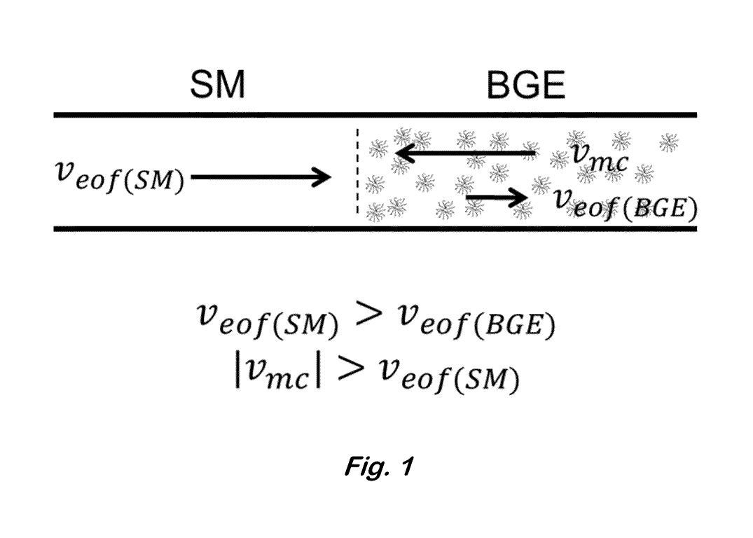

In one embodiment of the disclosed method, the apparent velocity of the micelle (v_{mc}) is towards the (+) inlet and SM/BGE boundary (FIG. 1). (Note that the polarities disclosed herein may be reversed when using a cationic micelle.) The flow (EOF and/or hydrodynamic) towards the (−) end is greater in the SM (v_{eof(SM)}) than in the BGE (v_{eof(BGE)}). These conditions can be achieved by addition of EOF modifiers including organic amines, polymers, polyelectrolytes, and ionic additives. Neutral analytes in SM all travel at same velocity towards SM/BGE boundary, while neutral analytes in the BGE travel at different velocities, dependent upon micelle affinity, towards the SM/BGE boundary. The SM/BGE boundary may be maintained in the separation channel by the application of hydrodynamic force. The hydrodynamic force may be necessary to ensure that the SM/BGE boundary does not exit the capillary on the inlet side. Hydrodynamic force can be established, for example, by applying pressure on the inlet side of the capillary, vacuum on the outlet side of the capillary, or raising or lowering the inlet and outlet vials relative to one another. The extent of focusing is controlled by attenuation of V_{eof(BGE)}, as it approaches zero, focusing is complete—assuming V_{eof(BGE)} is zero, all analyte with any affinity for the micelle will focus to SM/BGE boundary. During focusing analyte migrates to discrete zones dependent upon the analytes affinity for the micelle.

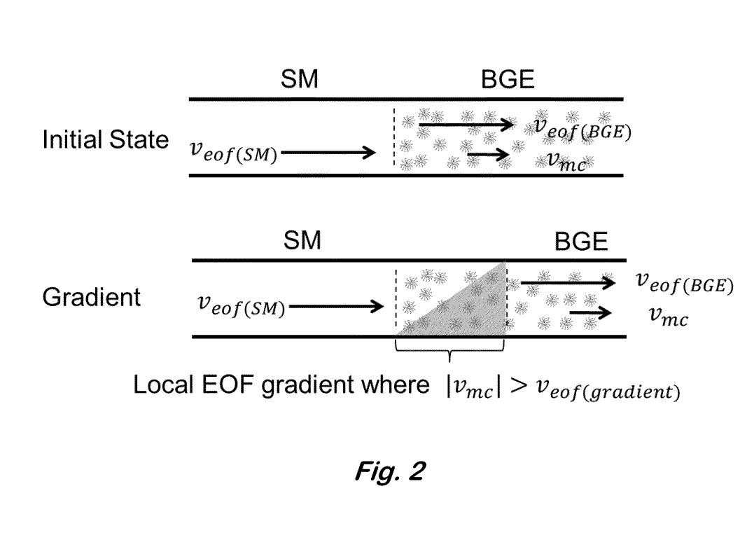

In other embodiment, v_{mc} towards the outlet is less than V_{eof(BGE)}, but there is also a local EOF gradient adjacent to the SM/BGE boundary where |v_{mc}|>v_{eof(gradient)} (FIG. 2). Upon application of voltage, a stable moving boundary between SM and BGE is established; no relationship between v_{eof(SM)} and V_{eof(BGE)} and/or hydrodynamic flow is required. Charged components of the SM penetrate into the BGE establishing a local EOF gradient, inducing conditions such that |v_{mc}|>v_{-eof(gradient)}. For example, for a seawater SM, sodium ions will penetrate into BGE and establish the gradient. The gradient may be later altered by the subsequent penetration into the BGE by less mobile ions such as potassium. Neutral analytes in SM all travel at same velocity towards SM/BGE boundary. Within the gradient, neutral analytes in the BGE travel at different velocities, dependent upon micelle affinity, towards the SM/BGE boundary. The effect is local to the gradient region, and is disrupted by replacing SM with BGE after a discrete injection. The presence of the gradient may be shown by injections of markers as explained in Example 1 below. Should the gradient region grow large relative to the length of the capillary, the SM/BGE boundary may begin to migrate towards the inlet side of the capillary. As in the previous embodiment, it may be necessary to use hydrodynamic force to maintain the boundary in the capillary during focusing.

The following examples are given to illustrate specific applications. These specific examples are not intended to limit the scope of the disclosure in this application.

### Example 1

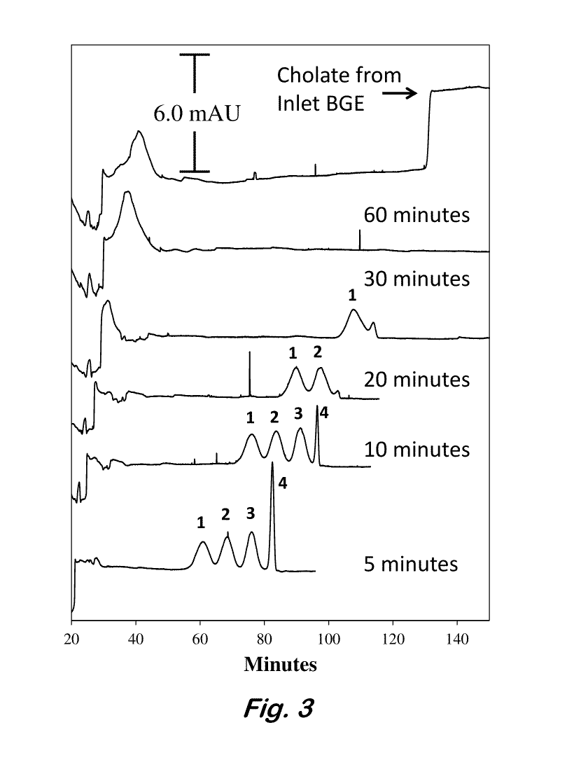

Mapping of cholate micelle movement as a function of length of time associated with an electrokinetic injection of seawater at a constant current of 120 μAmps—Four Sudan III containing BGE plugs (200 μM) were injected hydrodynamically at 8 cm intervals. Seawater sample matrix was injected for the times noted near the electropherogram increasing from bottom to top. The top trace (FIG. 3) shows the resultant electropherogram where Sudan III containing BGE is in the inlet vial during the separation after a 60 minute electrokinetic injection of seawater.

Separation BGEs for MEKC were prepared as follows: Stock solutions of sodium tetraborate (100 mM), and cholate (500 mM) were prepared. The sodium cholate-containing BGE (50 mL) was prepared by mixing the appropriate amount of tetraborate and sodium cholate stock solutions to give a final concentration, unless otherwise specified, of 10 mM tetraborate and 200 mM cholate; 10% v/v ethanol was also included to modify the analytes affinity for the micelle. BGE was filtered through a 0.22 μm filter (Millipore Express PES Membrane). Unless otherwise specified, the pH was not adjusted, and the final pH of the 50 mL solution was typically 9.1.

This example illustrates the EOF gradient that forms as a function of sample matrix penetrating the BGE. Micelle moves out of the column at the inlet side.

### Example 2

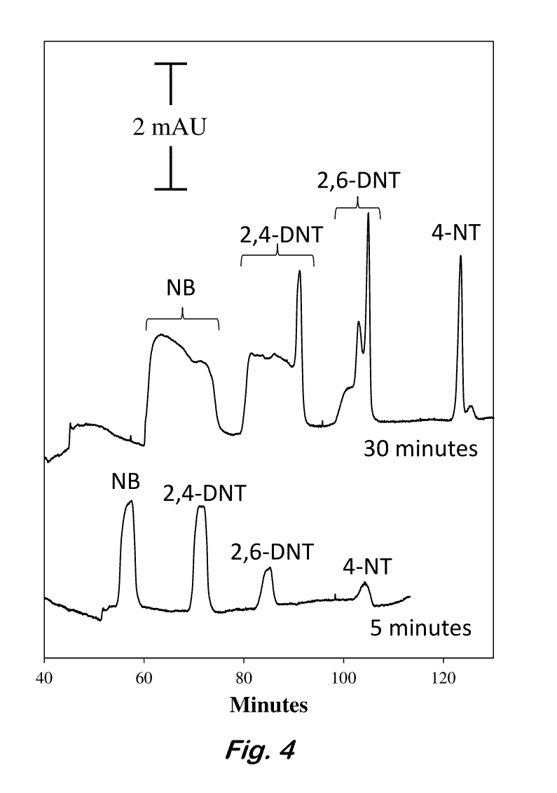

Electropherograms (FIG. 4) resulting from the electrokinetic injection of 500 ppb NB, 2,4-DNT, 2,6-DNT, and 4-NT—The BGE is modified with the additive DAB at a concentration of 4 mM. This example illustrates the EOF gradient that forms as a function of sample matrix penetrating the BGE. Typical square top peaks are observed for NB, 2,4-DNT, and 2,6-DNT, indicating that injection time had exceeded the traditional stacking mechanism. For the 30 minute injection, the stacking behavior, as indicated by peak shape, was different for each analyte and inconsistent with the behavior observed in the 5 minute injection. The injection had entered a focusing regime, with peak shape indicative of how focusing effects analytes as a function of affinity for the micelle. Specifically, NB presents as a typical square-top peak associated with an injection time that exceeds the stacking mechanism, the 2,4-DNT peak shows localized focusing on the inlet-side of the sample plug, the 2,6-DNT peak has a greater degree of focusing apparent while the 4-NT peak presents as a well stacked Gaussian peak when compared to its 5 minute injection counterpart. It should be noted that no hydrodynamic force was used to maintain the SM/BGE boundary in the capillary.

### Example 3

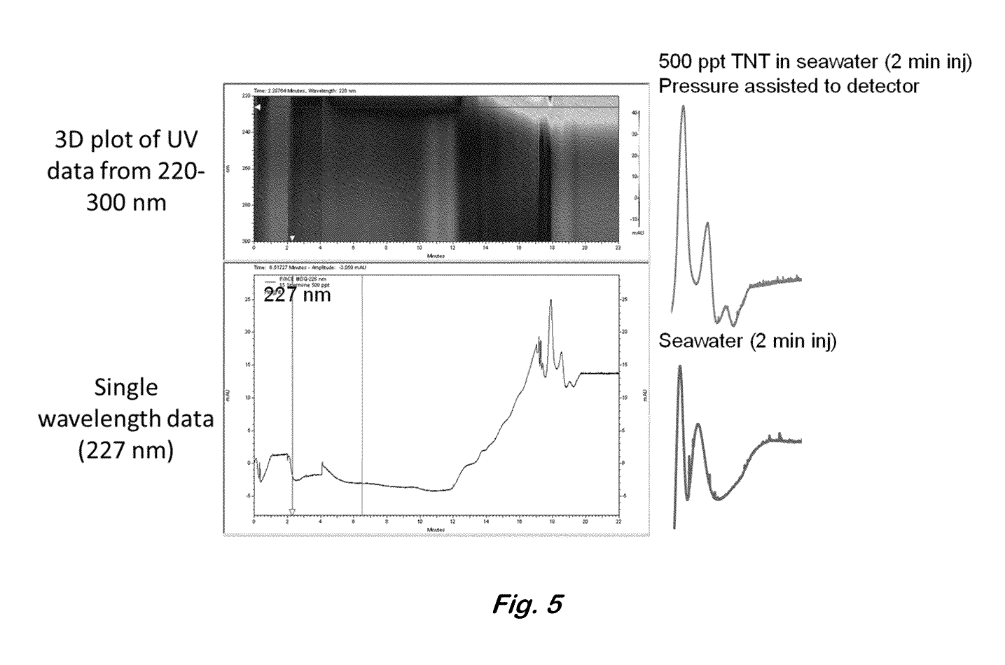

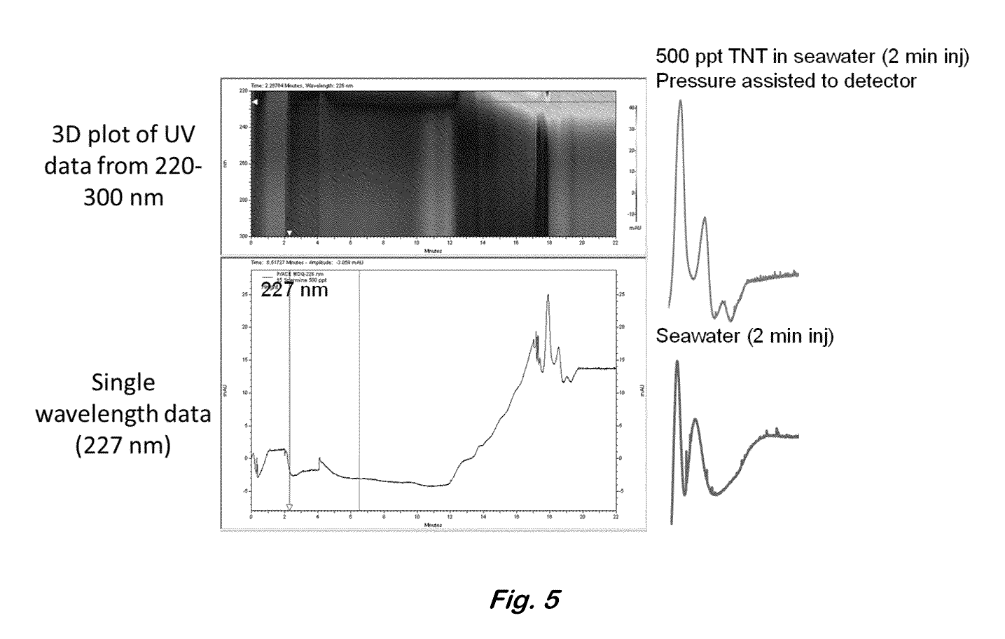

Demonstration of Analyte Focusing—The TNT sample (in seawater) was injected electrophoretically (with assisted pressure) into BGE containing 200 mM sodium cholate, 10 mM sodium tetraborate, and 15 mM spermine. Spermine is an EOF suppressor added to increase the stability of the focusing gradient. The BGE can self-suppress at high enough concentrations of the flow inhibitor. Hydrodynamic force was required to maintain the SM/BGE boundary in the capillary. After injection for two minutes, the sample was replaced with BGE and mobilized to a UV absorbance detector (electrophoretically with pressure assistance). FIG. 5 shows the peak associated with focused TNT compared to the absence of TNT.

Obviously, many modifications and variations are possible in light of the above teachings. It is therefore to be understood that the claimed subject matter may be practiced otherwise than as specifically described. Any reference to claim elements in the singular, e.g., using the articles “a”, “an”, “the”, or “said” is not construed as limiting the element to the singular.

What is claimed is:

1. A method comprising:
providing a electrokinetic chromatograph comprising a fluid channel comprising an inlet end and an outlet end, a background electrolyte comprising an electrokinetic vector filling the fluid channel, an inlet buffer container, an outlet buffer container, a voltage supply, and a detector;
injecting a sample matrix into the inlet end; and
applying a voltage across the fluid channel using the voltage supply for a time sufficient to allow an analyte in the sample matrix to be detected by the detector;
wherein the chromatograph, the background electrolyte, and the sample matrix are configured to produce:
a hydrodynamic flow, an electroosmotic flow, or a combination thereof towards the outlet end in the background electrolyte;
a hydrodynamic flow, an electroosmotic flow, or a combination thereof towards the outlet end in the sample matrix that is greater than the flow in the background electrolyte; and
a micelle velocity towards the inlet end.

2. The method of claim 1, when the electrokinetic vector is a micelle.

3. The method of claim 1, when the fluid channel is a glass capillary.

4. The method of claim 1, when the sample matrix or background electrolyte comprises an electroosmotic flow modifier.

5. The method of claim 4, wherein the electroosmotic flow modifier is an organic amine, a polymer, a polyelectrolyte, or an ionic additive.

6. A method comprising:
providing a electrokinetic chromatograph comprising a fluid channel comprising an inlet end and an outlet end, a background electrolyte comprising an electrokinetic vector filling the fluid channel, an inlet buffer container, an outlet buffer container, a voltage supply, and a detector;
injecting a sample matrix into the inlet end; and
applying a voltage across the fluid channel using the voltage supply for a time sufficient to allow an analyte in the sample matrix to be detected by the detector;
wherein the chromatograph, the background electrolyte, and the sample matrix are configured to produce:
a hydrodynamic flow, an electroosmotic flow, or a combination thereof towards the outlet end in a portion of the background electrolyte closer to the outlet end;
a hydrodynamic flow, an electroosmotic flow, or a combination thereof towards the outlet end in the sample matrix;
a micelle velocity in the portion of the background electrolyte towards the outlet end that is less than flow in the portion of the background electrolyte; and
an electroosmotic flow gradient between the portion of the background electrolyte and the sample matrix.

7. The method of claim 6, when the electrokinetic vector is a micelle.

8. The method of claim 6, when the fluid channel is a glass capillary.

9. The method of claim 6, wherein the background electrolyte comprises an electroosmotic flow inhibitor.

10. The method of claim 9, wherein the electroosmotic flow inhibitor is spermine.

11. The method of claim 6, wherein the electroosmotic flow gradient is caused by penetration of a species in the sample matrix into the background electrolyte.
